(19) United States
(12) Patent Application Publication
(10) Pub. No.: US 2002/0167612 A1
(43) Pub. Date: Nov. 14, 2002

(54) Device and method for reducing flicker in a video display

(75) Inventors: Glenn Waehner, Fresno, CA (US); James McWilliams, Newburgh, NY (US)

Correspondence Address: Alan M. Weisberg, Christopher & Weisbert, P.A., Suite 2040, 200 East Las Olas Boulevard, Fort Lauderdale, FL, 33301, US

(73) Assignee: Pelco

(21) Appl. No.: 10/115,110

(22) Filed: Apr. 2, 2002

Related U.S. Application Data
(60) Provisional application No. 60/280,875, filed on Apr. 2, 2001.

(51) Int. Cl. H04N 5/21

(52) U.S. Cl. 348/607; 348/910

(57) ABSTRACT

A device and method is provided for reducing flicker on a video display. The device may be incorporated into a video surveillance system having a number of cameras, monitors, a keyboard controller, a switch, and a flicker reduction circuit. The flicker reduction circuit processes dual interlaced fields of video data with a field FIFO memory area, a line FIFO memory area, and a logic unit. The field memory area acts as a delay to store the field previous to the field being processed, while the line memory area stores the least recent line input from the field memory area. The logic unit computes the flicker-reduced scan line intensity for a given scan line by averaging the given scan line intensity with the resultant scan line intensity average of the two immediately adjacent scan lines in the complementary field.

### CROSS-REFERENCE TO RELATED APPLICATION

This application is related to and claims priority to U.S. Provisional Application Serial No. 60/280,875, filed Apr. 02, 2001, entitled VIDEO SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to video displays, and in particular, to a device and method for reducing flicker on a surveillance system video display.

### BACKGROUND OF THE INVENTION

“Flicker” refers to the phenomenon whereby a video display screen appears to flicker. Screen flicker is a subjective perception that affects people differently. Some people perceive screen flicker where others do not. The human eye is mostly immune to flicker, although not as much so in the peripheral field of vision. Nevertheless, a persistent flicker on a video screen can be very distracting and tiring to the eyes.

Screen flicker results from a variety of factors, such as the rate at which the display, such as a monitor, is “refreshed”, i.e. the speed with which the screen is redrawn. If the refresh rate is too slow, the screen will appear to flicker. Another factor that affects screen flicker is the persistence of the screen phosphors. Low-persistence phosphors fade more quickly than high-persistence monitors, making screen flicker more likely. Screen flicker can also be affected by lighting.

Still another manifestation of flicker is when unequal amounts of energy reside in adjacent lines on alternate fields on a video screen. Television and video displays typically use a set of horizontal scan lines to display an image. Flicker results when the intensity of one scan line directly adjacent (above or below) another scan line, and therefore in an alternate field, varies by an extreme degree. An image example is black shutters on a white house. The sudden hard transition between the white house and black shutters will produce the flicker manifestation on the video monitor.

Present techniques to overcome this problem include scan line duplicators, which result in reduced vertical image resolution. Other systems use complex interpolation schemes to try and place interpolated lines in place of the original scan lines, and to adapt such interpolation to the various image conditions, resulting in costly and complex system components.

It is desirable therefore, to produce a device and method for minimizing flicker on a video screen, while retaining the maximum blend of vertical image resolution, cost-effectiveness, adaptability, and ease of use.

### SUMMARY OF THE INVENTION

The present invention advantageously provides a device and method for reducing flicker in a video display.

According to an aspect, the present invention provides a device having a digital video signal input, for processing a video signal. The digital video signal input includes a video line data having at least a first, second, and third video line, each video line having a corresponding intensity data. A first memory area having a first input and a first output is electrically connected to the digital video signal input. The first input receives the video line intensity data corresponding to the first video line. The first output transmits the video line intensity data corresponding to the second video line. A second memory area having a second input and a second output is electrically connected the first output. The second input receives video line intensity data corresponding to the second video line. The second output transmits the video line intensity data corresponding to the third video line. A logic unit electrically connected to the digital video signal input, the first output and the second output, includes third, fourth, and fifth inputs. The third input receives the video line intensity data corresponding to the first video line. The fourth input receives video line intensity data corresponding to the second video line. The fifth input receives the video line intensity data corresponding to the third video line. The logic unit is arranged to process the digital video signal input to produce a flicker-reduced output. The flicker-reduced output includes digital video line data having an intensity data substantially equal to the sum of: (i) approximately one quarter times the video line intensity data corresponding to the second video line, plus (ii) approximately one quarter times the video line intensity data corresponding to the third video line, plus (iii) approximately one half times the video line intensity data corresponding to the first video line.

According to another aspect, the present invention provides a video system which includes a camera, a keyboard controller, and a video display unit operatively connected to each other through a switch. The camera and switch produce a digital video signal which includes video line data having at least a first, second, and third video line, each video line having a corresponding intensity data. The switch further includes a digital to analog converter and a flicker reduction circuit having a first memory area, a second memory area, and a logic unit. The first memory area includes a first input and a first output and is electrically connected to the digital video signal input. The first input receives the video line intensity data corresponding to the first video line. The first output transmits the video line intensity data corresponding to the second video line. The second memory area includes a second input and a second output and is electrically connected the first output. The second input receives video line intensity data corresponding to the second video line. The second output transmits the video line intensity data corresponding to the third video line. The logic unit is electrically connected to the digital video signal input, the first output and the second output, and includes third, fourth, and fifth inputs. The third input receives the video line intensity data corresponding to the first video line. The fourth input receives video line intensity data corresponding to the second video line. The fifth input receives the video line intensity data corresponding to the third video line. The logic unit is arranged to process the digital video signal input to produce a flicker-reduced output. The flicker-reduced output includes digital video line data having an intensity data substantially equal to the sum of: (i) approximately one quarter times the video line intensity data corresponding to the second video line, plus (ii) approximately one quarter times the video line intensity data corresponding to the third video line, plus (iii) approximately one half times the video line intensity data corresponding to the first video line. The flicker-reduced output is input to the digital to analog converter. The digital to analog converter sends a flicker-reduced video signal to the video display unit.

In yet another aspect, the present invention provides a method of reducing flicker on a video display. A first digital video signal is read having a first primary field of video data and a first complementary field of video data. Each of the primary and complementary field includes a plurality of scan lines. Each of the plurality of scan lines includes an initial corresponding line intensity and is arranged in a sequence including at least a first scan line and a second scan line. The initial line intensities of the first and second scan lines of the first primary field are read. The initial line intensity of the first scan line of the first complementary field are read. A second digital video signal is produced having a second primary field and a second complementary field of video data. Each of the primary and complementary field of video data includes a sequence of scan lines having a resultant line intensity, the resultant line intensity of each scan line being substantially equal to the sum of: (i) approximately one quarter times the initial intensity of first scan line of the first primary field of the first digital video signal, plus (ii) approximately one quarter times the initial line intensity of the second scan line of the first primary field of the first digital video signal, plus (iii) approximately one half times the initial line intensity of the first scan line of the first complementary field of the first digital video signal.

Still another aspect of the present invention provides a method of reducing flicker in a video signal. A first digital video signal is read having at least a first scan line and a second scan line spatially adjacent to the first scan line. The first scan line and the second scan line include a first initial line intensity and second initial line intensity, respectively. A first relative line intensity difference between the at least first scan line initial line intensity and the second scan line initial line intensity is included in the first digital video signal. The first digital video signal is processed to redistribute the initial line intensities of the first scan line and second scan line to establish a second relative line intensity difference between the redistributed first scan line intensity and the redistributed second scan line intensity. The second relative line intensity difference is less than the first relative line intensity difference. A second digital video signal is generated from the processed first digital video signal.

Yet another aspect of the present invention provides a method of reducing flicker in a video signal. A first digital video signal having a plurality of scan lines is read. Each of the plurality of scan lines includes a corresponding initial line intensity and is arranged in a sequence including at least a first scan line, a second scan line, and a third scan line. The initial line intensities of the first, second and third scan lines of the first digital video signal is read. The first digital video signal is processed to produce a second digital video signal having a plurality of processed scan lines arranged in a sequence including at least a first processed scan line, a second processed scan line, and a third processed scan line, corresponding to the first, second and third scan lines of the first digital video signal, respectively. Each of the first, second and third processed scan lines includes a resultant line intensity. The resultant line intensity of the first processed scan line is greater than the initial line intensity of the of the first scan line of the first digital video signal. The resultant line intensity of the second processed scan line is less than the initial line intensity of the second scan line of the first digital video signal. The resultant line intensity of the third processed scan line is greater than the initial line intensity of the of the third scan line of the first digital video signal.

In still another aspect, the present invention provides a device for reducing flicker in a video signal, including an input adapted to receive an initial digital video signal, a memory element connected to the input, and logic unit connected to the input and the memory element. The digital video signal includes at least a first scan line and a second scan line spatially adjacent to the first scan line. The first scan line and the second scan line include a first initial line intensity and second initial line intensity, respectively. The digital video signal also includes a first relative line intensity difference between the at least first scan line initial line intensity and the second scan line initial line intensity. The memory element stores the initial line intensities of the first and second scan lines. The logic unit processes the first digital video signal to redistribute the initial line intensities of the first scan line and second scan line to establish a second relative line intensity difference between the redistributed first scan line intensity and the redistributed second scan line intensity. The second relative line intensity difference is less than the first relative line intensity difference. The logic unit generates a second digital video signal from the processed first digital video signal.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary video surveillance system arranged in accordance with the principles of the present invention;

FIG. 2 is a view of two video screens, before and after flicker has been reduced in accordance with the principles of the present invention;

FIG. 3 is a block diagram of a flicker reduction circuit arranged in accordance with the principles of the present invention; and

FIG. 4 is a flowchart showing the flicker reduction process executed by the flicker reduction circuit of FIG. 3.

### DETAILED DESCRIPTION OF THE INVENTION

As used herein, the term “raster” shall mean the rectangular area of a display screen or monitor actually being used to display images. In some cases, the raster is slightly smaller than the physical dimensions of the display screen so none of the display image is hidden by the bezel of the monitor. Also, the raster may vary for different resolutions of video images. The raster is in turn divided in a set of horizontal scan lines vertically stacked adjacent to one another. Each scan line bears a whole number index, j. In interlaced scan display arrangements, the raster lines are further divided into a pair of interlaced “fields”, each consisting of a sequence of scan lines. Those lines where j=odd represent the “odd” field, and those lines where j=even represent the “even” field. Each of the odd and even fields are thus “complementary” fields, in that each field defines a mutually exclusive set of scan lines, where any one given field may be initially labeled as the “primary” field and the other field being initially labeled as the complementary field. For a given video signal therefore, the odd field complements the even field to complete the signal, and vice versa.

Also as used herein, the term “memory area” means a single or multiple physical memory element, or a portion of a single physical memory element. A memory element is in turn used herein to define any device capable of storing digital information.

In accordance with NTSC (National Television Standards Committee) video standards, an NTSC raster consists of 525 total lines composed of two interlaced fields of 262 and one half lines each. Each field represents a single half-frame of video, and is displayed at 60 Hz. The present invention is equally suited to work with other television and video standards, such as PAL (Phase Alternating Line), which uses half-frames of 312 or 313 lines for a total of 625 lines, at 50 Hz.

Each scan line in a raster represents a number of samples of video information, arranged horizontally, such as pixels, with each pixel being represented in the video signal with a range of brightness, color, and spectral intensity data. For ease of explanation, the video signal of the described embodiment is monochromatic, and with each scan line having samples or pixels of equal intensity. As used herein, the term “intensity” shall mean the relative darkness of a line, rather than the relative brightness, with an intensity of 100% corresponding to fully black, and an intensity of 0% corresponding to fully white. It is understood by a person of ordinary skill in the art that the convention for intensity may be reversed, with 100% representing fully white rather than fully black. Of course the present invention can be embodied using a color video signal having pixels and/or scan lines of varying intensity.

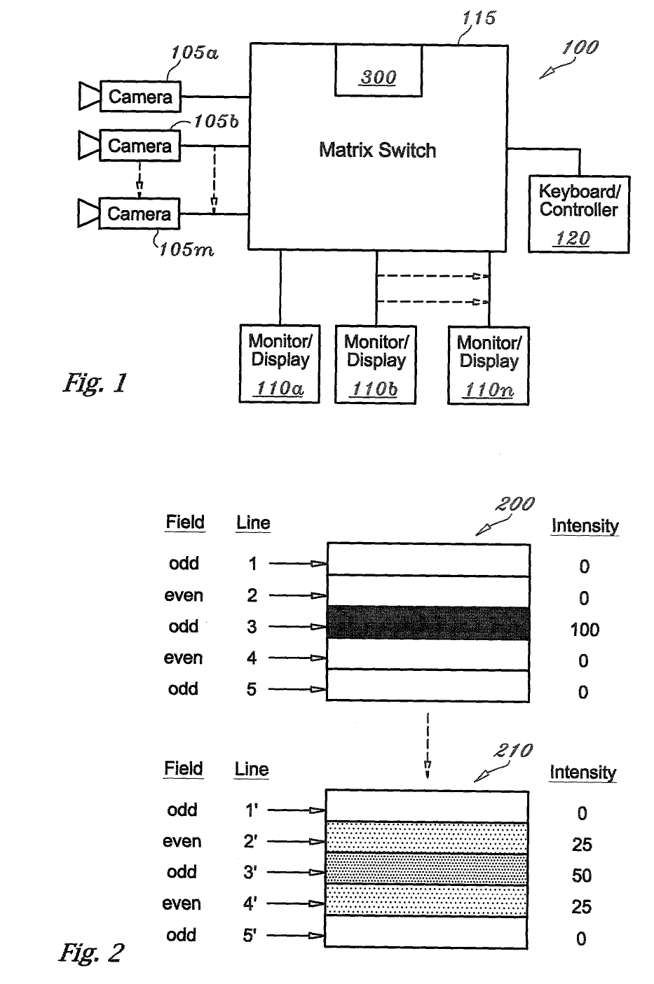

Referring now to the drawing figures, in which like reference designators refer to like elements, there is shown in FIG. 1 a block diagram of a video surveillance system, such as a closed circuit television (CCTV) system, for use in monitoring multiple scenes from multiple locations, constructed in accordance with the principles of the present invention and designated generally as 100. System 100 includes up to “m” video cameras 105a, 105b, through 105m, along with up to “n” video monitors or displays 110a, 110b, through 110n, (where “m” and “n” are whole numbers) coupled to a video switch, having at least one keyboard controller 120 connected thereto.

The cameras 105 may be any of a variety of video or still cameras, acquiring a picture using a lens, iris, zoom and focus controls, integrated optics package, or other image acquisition device. The cameras 105 may be included inside of a housing such a semi-hemispherical dome, suitable for affixation onto a surface. The housing may also include a set of orientational controls, such as pan and tilt motors and actuators for moving and orienting the direction of the image acquisition device. An example of such a camera 105 and housing is the SPECTRA series of video surveillance units manufactured by Pelco.

Each camera 105 is connected to the video switch 115, such a multi-input and output “matrix” switch. The switch 115 contains a variety of components, including a computer and control circuit electronics for controlling the operation of each camera 105, through commands and codes received by the keyboard controller 120. Both the cameras 105 and keyboard controller 120 may be disposed at remote locations from the switch 115. The switch 115 is further connected to a number “n” of monitor displays 110. The “matrix” therefore, contains m×n channels for m camera inputs and n monitor outputs. One example of such a matrix switch is the CM 6800 switch manufactured by Pelco, which provides m=48 and n=8. The keyboard controller 120 is further used to control the appearance of the video signals on the monitors 110, such the overall brightness, contrast, and the nature of the display of character text onto the images acquired by the cameras 105, as more fully described below. Switch 115 may also include a flicker reduction circuit 300, as more fully discussed below.

FIG. 2 illustrates two views 200 and 210 of a simplified video display raster, each composed of five total lines, where line index j ranges from 1 to 5, and lines 1, 3, and 5 represent the odd field, and lines 2 and 4 represent the even field. View 200 illustrates the raster appearance before the flicker reduction circuit of the present invention has processed the video signal. Line 3 has a intensity of 100, and is immediately surrounded by lines 2 and 4 which have zero intensity. While lines 1 through 5 show the raster prior to processing by the flicker reduction circuit 300, lines 1′ through 5′ represent the raster after processing by the flicker reduction circuit 300.

For a given line in a given field, the flicker reduction circuit 300 processes the video signal such that the intensity of each line of video is adjusted to equal the average of the initial intensity of such target line and the average of the intensities of the lines immediately above and below the target line in the complementary field. If each scan line intensity is denoted by Iⱼ, where j represents the line index, Iⱼ^{old} represents the intensity prior to processing by the flicker reduction circuit 300, and Iⱼ^{new} represents the intensity after processing by the flicker reduction circuit 300, then, the following formula describes the process of the present invention:

$${I}_{j}^{new} = \frac{{I}_{j}^{old} + 1 / 2 * ( {I}_{j + 1}^{old} + {I}_{j - 1}^{old} )}{2}$$

In accordance with this formula, first the intensity of the lines immediately below and above the target line are retrieved and averaged, and the result is then averaged with the intensity of the target line. Since the fields are interlaced, the intensity of lines from odd fields are calculated and processed for even field target lines, and vice versa.

By way of example, if line 2 of display 200, having an initial intensity of zero, is processed, the intensity equals: ½*(0+1/2*(100+0))=25. Thus line 2′in display 210 is 25, it being understood that 25 is one-quarter of 100, or one quarter the intensity of line 3. Line 3 in display 200 is processed and equals: ½*(100+½*)(0+0))=50. Thus line 3′ in display 210 is 50. Finally, line 4 is processed and equals ½*(0+½*(100+0))=25. Thus line 4′ in display 210 is 25, the very same as line 2′ due to the symmetry of the displays.

This process may be applied to any number of scan lines, each having a varying range of relative intensities. For example, if six scan lines having intensities of: {0, 0, 1, 1, 0, 0} are processed, the flicker reduction circuit 300 processes the intensities to become: {0, 1/4, 3/4, 3/4, 1/4, 0}. In each case, the overall spectral intensity across the breadth of the display is preserved. The “energy” of each line is redistributed to the adjacent lines, while the aggregate energy of all lines is constant.

The overall result of this process to smooth out the transition from lines of varying intensity, such that when the interlaced fields of video are alternately shown in a raster screen, the annoying flicker which would be produced by display 200 is advantageously lessened when converted to display 210.

While the foregoing contemplates a redistribution of line intensity in certain proportions, it is understood that the effect of lessening flicker is achieved if such proportions are varied, as long as the relative intensity difference between adjacent lines is lessened via a redistribution of intensity between the lines. For example, while the foregoing description of the invention contemplated a redistribution of energy from lines having initial intensities of {0,1,0} to {1/4, 1/2, 1/4}, the redistribution of intensity could be of varying proportions, such as from {0,1,0} to {1/6, 2/3, 1/6}, and flicker would still be reduced.

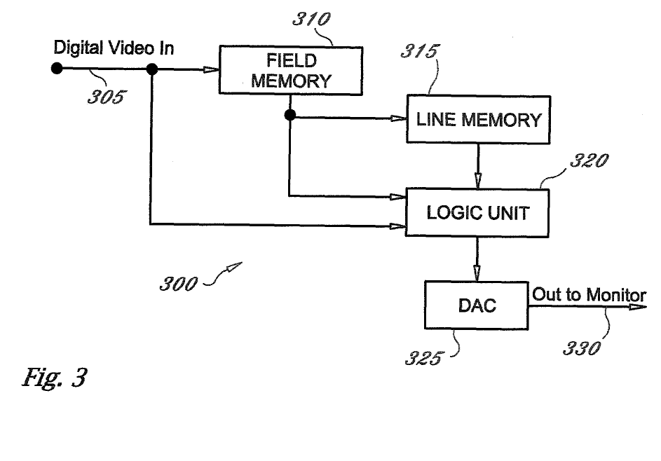

FIG. 3 is a block diagram of the flicker reduction circuit 300 arranged in accordance with the principles of the present invention. As stated above with respect to the video surveillance system of FIG. 1, the flicker reduction circuit 300 may be arranged with the components or main board of the processors in switch 115. Alternatively, the flicker reduction circuit may be arranged in any one of the monitors 110, or in a device electrically coupled between monitors 110 and switch 115.

Flicker reduction circuit 300 includes a digital video input 305, a field memory area 310, a line memory area 315, a logic unit 320, an optional digital to analog converter (DAC), and an output line 330 to a monitor, such as the displays 110 of video surveillance system 100. A digital video signal, made up of digital words, is first applied to the circuit 300, made up of digital words, and corresponds to two synchronized, interlaced fields of video scan lines, as discussed above. The digitization process may take place in any preferred manner, such for example, in the switch 115 after any one of the video cameras 105 acquires an image signal.

Field memory area 300 may be any digital memory area, and is preferably a FIFO (first-in first-out) device. The line memory area 315 is also a digital memory area, and is also preferably a FIFO device. While the field memory area is much larger than the line memory area, the actual memory capacities of each component may vary according to the data contained in the particular video signal to be processed. One is example for the field memory size is about 300 megabytes while the line memory may be approximately 720 bytes. The field memory area 310 is arranged to store all of one field, odd or even, of the input digital video signal 305. The line memory area 315 is arranged to store only one scan line of video from any one of the fields in signal 305.

Logic unit 320 is a digital device programmed to add and divide (or shift) bits representing the digital words coming out of the field memory area 310 and line memory area 315, each of which is connected to such logic unit 320 as shown in FIG. 3. Logic unit 320 may be any digital logic device or chip such as Field Programmable Gate Array (FPGA). The circuit 300 may also include a DAC 325 which receives the output of the logic unit 320, to convert the resulting signal from the unit 320 to analog before output to a display monitor.

First, the circuit 300 must be “primed”, in that all lines an entire field from input 305 are sequentially loaded into the field memory area 310, and the first line from such field is loaded into the line memory area 315. The circuit 300 is then ready to process the rest of the digital video signal 305.

Generally, at any point in time, for a target line j in a given target field, the field memory area 310 holds all lines from zero to j−2 in the target field, and from lines j−1 to N in the opposite field, j being incremented by 2 in each range. N in this case is related to the maximum number of lines in each field, and includes an allocation of extra lines before and after the viewable lines in the raster, to account for edge conditions and vertical blanking areas, as is commonly known to those of ordinary skill in the art. Line j is then routed to the logic unit 320 processing, and enters the field memory area 310. Since field memory area 310 is operated as a FIFO device, and the oldest line stored therein is j−1, line j−1 exits field memory area 310 while line j is added. The next oldest line, j+1 is thus routed to the logic unit 320, which averages lines j−1 from line memory area 315 with line j+1 from the field memory area 310. Line j+1 is thereafter enters line memory area 315 and causes line j−1 to exit therefrom. The resulting average of: (j−1 and j+1) is averaged with j in the logic unit 320, and a new signal for j is output to the DAC 325. The next line j+2 is then entered in field memory area 310, and the entire process is repeated as above, until reaches up to N for that field.

For example, if j=48, then the field memory area stores lines:

{46, 44, 42, . . . , 6, 4, 2, N, N−2, N−4, . . . 51, 49, 47}

where N, N−2, N−4 are odd numbers. Correspondingly, the line memory area 315 stores line 47. As line 48 is read into the logic unit 320, line 48 also enters the field memory area 310 which causes line 47 to exit therefrom. The field memory area 310 then contains lines:

{48, 46, 44, 42, . . . , 6, 4, 2, N, N−2, N−4, . . . , 51, 49}

Line 49 is thus read from field memory area 310 into the logic unit 320, which takes the average of line 47 and 49, and averages that result with line 48. The net result is then output by the flicker reduction circuit 300 for line 48. The process then continues with line 50, and so on.

Once an entire field is entered through the circuit 300, the opposite field is then routed through, and the entire process repeats, until both the odd and even fields comprising an entire frame of a video signal are processed.

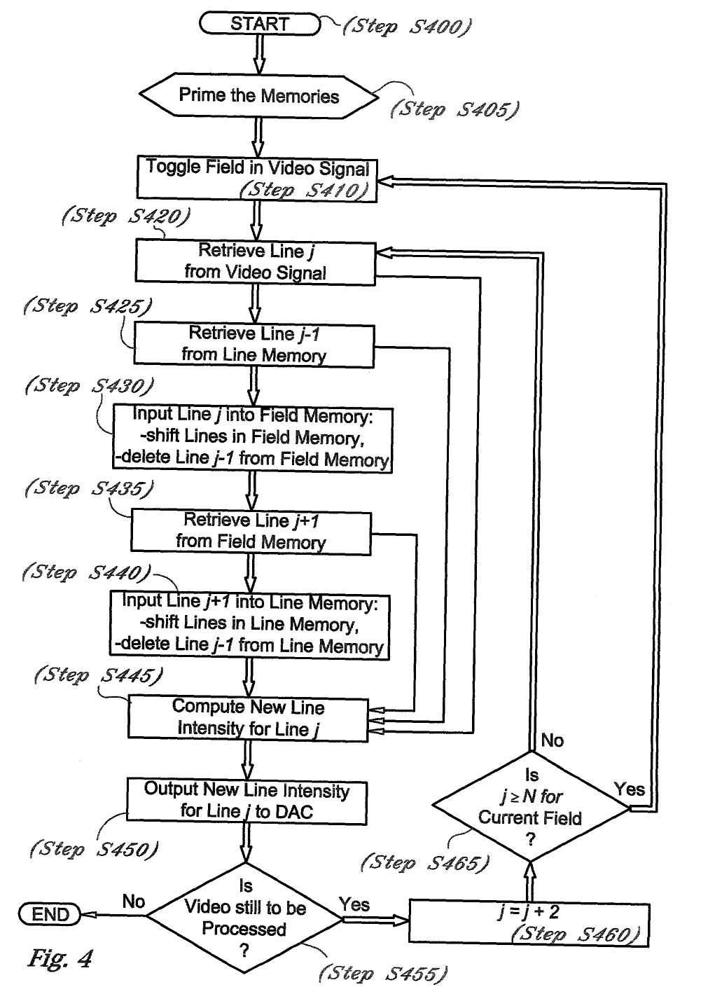

FIG. 4 shows a flowchart illustrating the process by which the flicker reduction circuit 300 processes the intensities of scan lines in complementary odd and even fields of a video signal. The process commences (step S400) and the flicker reduction circuit 300 is initialized when the field memory area 310 and line memory area 315 are “primed” (step S405), whereby the field memory area 310 is filled with an entire field of lines and the line memory area 315 is filled with the least recent line entered into the field memory area 310.

The next field in the video signal is chosen or “toggled”, the next video field being the field complementary to the field residing in the field memory area (step S410). This step is essentially self-executing, since the digital video signal entering flicker reduction circuit 300 oscillates between the two fields, as explained above.

Referring now to FIGS. 3 and 4 together, for the given current field, the flicker reduction circuit 300 retrieves the line intensity value for current line j from the video signal 305 (step S420). This line intensity value is routed to the logic unit 320. Next, in step S425, the line intensity of line j−1 residing in the line memory area 315 is read by the logic unit 320. Line j, retrieved from the video signal 305, is also input into the field memory area 310, shifting the lines in such memory and deleting the least recent line therein, line j−1, from the memory (step S430). The least recent line in field memory area 310 now becomes line j+1, since the line index for the lines in the memory increments by 2. The logic unit 320 now retrieves the line intensity value of line j+1 from the field memory area 310 (step S435). The shifting of lines in step S430 also triggers in the shifting of the one line in the line memory area 315 in step S440, where line j+1 is read into the line memory area 315, and line j−1 is deleted therefrom.

At this point, the logic unit 320 has retrieved three inputs, the line intensities of lines j, j−1 and j+1. The logic unit calculates a new line intensity for line j based on the above-listed formula, which equals the sum of (i) one quarter of the line intensity for line j−1, plus (ii) one quarter of the line intensity for line j+1, plus (iii) one half of the line intensity of line j (step S445). The new value intensity value for line j is then output to the DAC 450 for eventual routing to the video display (step S450).

If video is still to be processed (step S455) then the process continues on to step S460, otherwise, the process ends. In step S460 the next line is read into the flicker reduction circuit 300 from the video signal 305, such that the line index increments by 2. If the current field has ended, then the circuit 300 toggles to choose the first line in the complementary field, returning the process to step S410, or, if otherwise, the next line in the field is input into the circuit, returning the process to step S420 (step S465).

The present invention therefore takes in a video signal having adjacent lines of sharply varying intensity, and redistributes the line intensity across surrounding lines. Due to the timing of the display of interlaced fields in NTSC or PAL signals, this effectively reduces the flicker that would otherwise result if the flicker reduction circuit 300 of the present invention did not process such signal. Furthermore, the present invention minimizes the loss of vertical resolution, since the redistribution of energy between adjacent scan lines in proportionately less significant when the adjacent scan lines having relatively less of a contrast in intensity. The flicker reduction circuit 300 only minimally affects the vertical resolution of the “flicker” lines, while leaving the rest of the picture only minimally altered. A viewer of the flicker reduced signal and picture is not distracted or tired by the flicker, and is the overall viewing of the video image is enhanced while minimizing the loss of vertical resolution.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for processing a video signal, comprising:
a digital video signal input comprising video line data, the video line data comprising at least a first, second, and third video line, each video line having a corresponding intensity data;
a first memory area having:
a first input electrically connected to the digital video signal input to receive the video line intensity data corresponding to the first video line, and
a first output transmitting the video line intensity data corresponding to the second video line;
a second memory area having:
a second input electrically connected the first output to receive video line intensity data corresponding to the second video line, and
a second output transmitting the video line intensity data corresponding to the third video line; and
a logic unit electrically connected to the digital video signal input, the first output and the second output, the logic unit having third, fourth, and fifth inputs, the third input receiving the video line intensity data corresponding to the first video line, the fourth input receiving video line intensity data corresponding to the second video line, the fifth input receiving the video line intensity data corresponding to the third video line, the logic unit being arranged to process the digital video signal input to produce a flicker-reduced output, the flicker-reduced output comprising digital video line data having an intensity data substantially equal to the sum of:
(i) approximately one quarter times the video line intensity data corresponding to the second video line, plus
(ii) approximately one quarter times the video line intensity data corresponding to the third video line, plus
(iii) approximately one half times the video line intensity data corresponding to the first video line.

2. The device of claim 1, wherein the digital video signal input comprises a primary and a complementary field of video data, each of the primary and complementary field of video data having a plurality of field lines, each of the plurality of field lines having a corresponding intensity data, each of the plurality of field lines being arranged in a sequence including at least a first field line and a second field line.

3. The device of claim 2, wherein the first memory area is a digital FIFO memory area arranged to store one of the primary and complementary fields of video data, and the second memory area is a digital FIFO memory area arranged to store one of the plurality of field lines of one of the primary and complementary fields of video data.

4. The device of claim 3, wherein the digital video signal input oscillates between the primary and complementary fields at a fixed frequency, and wherein the first memory area sequentially stores the sequence of the plurality of field lines of the primary field, and wherein the second memory area stores the first line of the sequence of the plurality of field lines of the primary field.

5. The device of claim 4, wherein the first memory area sequentially reads and stores the digital video signal input, and receives the first field line of the sequence of the plurality of field lines of the complementary field, and wherein the second memory area reads and stores the second of the sequence of the plurality of field lines of the primary field.

6. The device of claim 5, wherein the first video line corresponds to the first field line of the sequence of the plurality of field lines of the complementary field, the second video line corresponds to the second field line of the sequence of the plurality of field lines of the primary field, and the third video line corresponds to the first field line of the sequence of the plurality of field lines of the primary field.

7. The device of claim 6, wherein the flicker-reduced output is a field line of video data having an intensity substantially equal to the sum of:
(i) approximately one quarter times the intensity data of the first field line of the sequence of the plurality of field lines of the primary field, plus
(ii) approximately one quarter times the intensity data of the second field line of the sequence of the plurality of field lines of the primary field, plus
(iii) approximately one half times the intensity data of the first field line of the sequence of the plurality of field lines of the complementary field.

8. The device of claim 2, wherein the digital video signal is compatible with a video format selected from a group consisting of NTSC and PAL.

9. The device of claim 1, wherein the logic unit is a field programmable gate array.

10. The device of claim 1, further comprising:
a digital to analog converter electrically connected to the flicker-reduced output.

11. A video system, comprising
a camera;
a keyboard controller;
a video display unit;
a switch, the camera, keyboard controller and video display unit being operatively connected to each other through the switch, the camera and switch producing a digital video signal comprising video line data, the video line data comprising at least a first, second, and third video line, each video line having a corresponding intensity data, the switch having a flicker reduction circuit, the flicker reduction circuit having:
a first memory area having:
a first input electrically connected to the digital video signal to receive the video line intensity data corresponding to the first video line, and
a first output transmitting the video line intensity data corresponding to the second video line;
a second memory area having:
a second input electrically connected the first output to receive video line intensity data corresponding to the second video line, and
a second output transmitting the video line intensity data corresponding to the third video line; and
a logic unit electrically connected to the digital video signal, the first output and the second output, the logic unit having third, fourth, and fifth inputs, the third input receiving the video line intensity data corresponding to the first video line, the fourth input receiving video line intensity data corresponding to the second video line, the fifth input receiving the video line intensity data corresponding to the third video line, the logic unit being arranged to process the digital video signal to produce a flicker-reduced output, the flicker-reduced output comprising digital video line data having an intensity data substantially equal to the sum of:
(i) approximately one quarter times the video line intensity data corresponding to the second video line, plus
(ii) approximately one quarter times the video line intensity data corresponding to the third video line, plus
(iii) approximately one half times the video line intensity data corresponding to the first video line; and
a digital to analog converter electrically connected to the switch and to the video display unit, the flicker-reduced output being input to the digital to analog converter, the digital to analog converter sending a flicker-reduced video signal to the video display unit.

12. The system of claim 11, wherein the digital video signal comprises a primary and a complementary field of video data, each of the primary and complementary field of video data having a plurality of field lines, each of the plurality of field lines having a corresponding intensity data, each of the plurality of field lines being arranged in a sequence including at least a first field line and a second field line.

13. The system of claim 12, wherein the first memory area is a digital FIFO memory area arranged to store one of the primary and complementary fields of video data, and the second memory area is a digital FIFO memory area arranged to store one of the plurality of field lines of one of the primary and complementary fields of video data.

14. The system of claim 13, wherein the digital video signal oscillates between the primary and complementary fields at a fixed frequency, and wherein the first memory area sequentially stores the sequence of the plurality of field lines of the primary field, and wherein the second memory area stores the first line of the sequence of the plurality of field lines of the primary field.

15. The system of claim 14, wherein the first memory area sequentially reads and stores the digital video signal, and receives the first field line of the sequence of the plurality of field lines of the complementary field, and wherein the second memory area reads and stores the second of the sequence of the plurality of field lines of the primary field.

16. The system of claim 15, wherein the first video line corresponds to the first field line of the sequence of the plurality of field lines of the complementary field, the second video line corresponds to the second field line of the sequence of the plurality of field lines of the primary field, and the third video line corresponds to the first field line of the sequence of the plurality of field lines of the primary field.

17. The system of claim 16, wherein the flicker-reduced output is a field line of video data having an intensity substantially equal to the sum of:
(i) approximately one quarter times the intensity data of the first field line of the sequence of the plurality of field lines of the primary field, plus
(ii) approximately one quarter times the intensity data of the second field line of the sequence of the plurality of field lines of the primary field, plus
(iii) approximately one half times the intensity data of the first field line of the sequence of the plurality of field lines of the complementary field.

18. A method of reducing flicker on a video display, comprising:
reading a first digital video signal having a first primary field of video data and a first complementary field of video data, each of the primary and complementary field including a plurality of scan lines, each of the plurality of scan lines having an initial corresponding line intensity, each of the plurality of scan lines being arranged in a sequence including at least a first scan line and a second scan line;
reading the initial line intensities of the first and second scan lines of the first primary field;
reading the initial line intensity of the first scan line of the first complementary field; and
producing a second digital video signal, having a second primary field and a second complementary field of video data, each of the primary and complementary field of video data including a sequence of scan lines, each scan line having a resultant line intensity, the resultant line intensity of each scan line being substantially equal to the sum of: (i) approximately one quarter times the initial intensity of first scan line of the first primary field of the first digital video signal, plus (ii) approximately one quarter times the initial line intensity of the second scan line of the first primary field of the first digital video signal, plus (iii) approximately one half times the initial line intensity of the first scan line of the first complementary field of the first digital video signal.

19. The method of claim 18, further comprising the steps of:
storing the first primary field of the first digital video signal in a first FIFO memory area;
storing the first scan line of the first primary field of the first digital video signal in a second FIFO memory area;
inputting the first scan line of the first complementary field to the first FIFO memory area;
shifting the scan lines of the first primary field stored in the first FIFO memory area to read the first scan line of the first complementary field and to delete the first scan line of the first primary field;
inputting the second scan line of the first primary field stored in the first FIFO memory area into the second FIFO memory area; and
shifting the first scan line of the first primary field stored in the second FIFO memory area to read the second scan line of the first primary field and to delete the first scan line of the first primary field.

20. The method of claim 18, wherein the first digital video signal is compatible with a video format selected from a group consisting of NTSC and PAL, and the second digital video signal is compatible with a video format selected from a group consisting of NTSC and PAL.

21. A method of reducing flicker in a video signal, comprising the steps of:
reading a first digital video signal, the first digital video signal having:
at least a first scan line and a second scan line spatially adjacent to the first scan line, the first scan line and the second scan line having a first initial line intensity and second initial line intensity, respectively; and
a first relative line intensity difference between the at least first scan line initial line intensity and the second scan line initial line intensity;
processing the first digital video signal to redistribute the initial line intensities of the first scan line and second scan line to establish a second relative line intensity difference between the redistributed first scan line intensity and the redistributed second scan line intensity, the second relative line intensity difference being less than the first relative line intensity difference; and
generating a second digital video signal from the processed first digital video signal.

22. A method of reducing flicker in a video signal, comprising the steps of:
reading a first digital video signal having a plurality of scan lines, each of the plurality of scan lines having a corresponding initial line intensity, the plurality of scan lines being arranged in a sequence including at least a first scan line, a second scan line, and a third scan line;
reading the initial line intensities of the first, second and third scan lines of the first digital video signal;
processing the first digital video signal to produce a second digital video signal having a plurality of processed scan lines, the plurality of processed scan lines being arranged in a sequence including at least a first processed scan line, a second processed scan line, and a third processed scan line, corresponding to the first, second and third scan lines of the first digital video signal, respectively, each of the first, second and third processed scan lines having a resultant line intensity, the resultant line intensity of the first processed scan line being greater than the initial line intensity of the of the first scan line of the first digital video signal, the resultant line intensity of the second processed scan line being less than the initial line intensity of the of the second scan line of the first digital video signal, the resultant line intensity of the third processed scan line being greater than the initial line intensity of the of the third scan line of the first digital video signal.

23. A device for reducing flicker in a video signal, comprising:
an input adapted to receive an initial digital video signal having:
at least a first scan line and a second scan line spatially adjacent to the first scan line, the first scan line and the second scan line having a first initial line intensity and second initial line intensity, respectively; and
a first relative line intensity difference between the at least first scan line initial line intensity and the second scan line initial line intensity,
a memory element connected to the input, the memory element storing the initial line intensities of the first and second scan lines;
a logic unit connected to the input and the memory element, the logic unit processing the first digital video signal to redistribute the initial line intensities of the first scan line and second scan line to establish a second relative line intensity difference between the redistributed first scan line intensity and the redistributed second scan line intensity, the second relative line intensity difference being less than the first relative line intensity difference, the logic unit generating a second digital video signal from the processed first digital video signal.
